(19) United States
(12) Patent Application Publication
(10) Pub. No.: US 2004/0026803 A1
(43) Pub. Date: Feb. 12, 2004

(54) Process for producing polymer optical waveguide and producing apparatus therefor

(75) Inventors: Kazutoshi Yatsuda, Ashigarakami-gun (JP); Keishi Shimizu, Ashigarakami-gun (JP); Shigemi Ohtsu, Ashigarakami-gun (JP); Eiichi Akutsu, Ashigarakami-gun (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/389,819

(22) Filed: Mar. 18, 2003

(30) Foreign Application Priority Data
Aug. 6, 2002 (JP) 2002-228288

(51) Int. Cl. G02B 1/12; G02B 6/02; G02B 6/10

(52) U.S. Cl. 264/1.27; 264/311; 385/129

(57) ABSTRACT

A process for producing a polymer optical waveguide, including the steps of: preparing a mold comprising a concave portion for forming a core; bringing a cladding film substrate, having good adhesiveness to the mold, into close contact with the mold; rotating the mold with which the cladding film substrate is brought into close contact and with one end of which an ultraviolet ray-curable resin or a thermosetting resin to serve as a core is brought into contact, so that a centrifugal force acts in a direction to move the ultraviolet ray-curable resin or the thermosetting resin into the mold, to fill the concave portion of the mold with the ultraviolet ray-curable resin or the thermosetting resin; and curing the ultraviolet ray-curable resin or the thermosetting resin.

### BACKGROUND OF THE INVENTION

1. Field of the Invention

The present invention relates to an optical waveguide, in particular, a process for producing a flexible polymer optical waveguide at low cost. The present invention also relates to an apparatus for producing the polymer optical waveguide.

2. Description of the Related Art

Various kinds of processes for producing a polymer optical waveguide have been proposed, including: (1) a process in which films are impregnated with a monomer, a core portion is selectively exposed to light to alter a refractive index and then the films are stuck together (a selective polymerization process), (2) a process in which a core layer and a cladding layer are formed by coating, followed by application of reactive ion etching to form a clad portion (RIE method), (3) a process in which an ultraviolet ray-curable resin as a polymer material added with a photosensitive material thereto is exposed and developed using a photolithographic technique (a direct exposure method), (4) a process using injection molding, (5) a process in which a core layer and a cladding layer are formed by coating, followed by exposure of the core portion to light to thereby alter a refractive index thereof (a photobleaching process) and others.

Problems to be solved still remain, however, in the above respective processes, as follows: The selective polymerization process (1) is problematic in lamination of the films, the processes (2) and (3) are costly since a photolithographic technique is adopted, the process (4) has a problem in precision of an obtained core diameter and the process (5) has a problem of providing no sufficient difference in refractive index between the core and cladding layers.

While processes excellent in performance and practical in use are currently limited to the processes (2) and (3), each has a cost problem to be solved. Furthermore, neither of the methods (1) and (5) is suitable for formation of a polymer optical waveguide in a flexible plastic substrate with a large area.

As a process for producing a polymer optical waveguide, a process is known in which a patterned substrate (cladding layer) in which a pattern of grooves functioning as capillaries is formed is filled with a polymer precursor material for a core, the polymer precursor material is thereafter cured to form a core layer, and then, a planar substrate (cladding layer) are stuck thereon. According to this process, however, not only the capillary grooves but also the entirety of a clearance between the patterned substrate and the planar substrate are filled with the polymer precursor material, and the polymer precursor material is cured thereby forming a thin layer having the same composition as the core layer. As a result a problem arises in that light is leaked out through the thin layer.

As one of measures to solve the problem, David Heard proposed a process for producing a polymer optical waveguide in which a patterned substrate on which a pattern of grooves functioning as capillaries is formed and a planar substrate are fixed onto each other with a clamping tool, a gap between the patterned substrate and the planar substrate in contact with each other is sealed with a resin and thereafter, the capillaries are filled with a monomer (diallyisophthalate) solution under a reduced pressure (Japanese Patent No. 3151364). This method uses a monomer instead of a polymer precursor material as a core forming resin material to provide a low viscosity filling material, and capillarity in capillaries is used to cause the capillaries to be filled with the filling material except for clearances other than the capillaries.

Since a monomer is used as a core forming material in this process, however, molecules of the monomer are polymerized to a polymer with the result of a great volume shrinkage during polymerization, causing a problem of a great transmission loss in a polymer optical waveguide.

Furthermore, this process is complicated since a patterned substrate and a planar substrate are fixed onto each other with a clamp and in addition to this, a gap between both substrates in contact with each other is sealed with a resin, which has a demerit for mass production, and as a result, no expectation of a cost down could be realized. Moreover, this process cannot be applied in fabrication of a polymer optical waveguide using a film, as a cladding layer, of the order of mm, or 1 mm or less in thickness.

Furthermore, recently, George M. Whitesides and his colleagues of Harvard University advocate a technique called capillary micromolding as a new technique fabricating a nonostructure and as one example of a soft lithography. This is a process in which a master substrate is fabricated using a photolithographic technique, a nanostructure on the master substrate is imprinted on a polydimethyl siloxane (PDMS) mold using adhesiveness and good peelability of PDMS and a liquid polymer is poured into the mold with the help of capillarity and then hardened. A detailed commentary on the process is described in Scientific American, September, 2001 issue (Nikkei Science (Japanese Periodical) December, 2001 issue).

The technique was filed as a patent application concerning a capillary micromolding method by Kim Enoch et al.: members of a group led by George M. Whitesides of Harvard University (see Specification of U.S. Pat. No. 6,355,198).

Even if a process described in the U.S. patent is applied to the producing of a polymer optical waveguide, it takes a long time to form a core portion, disabling application to mass production because of a small area of the core portion of an optical waveguide. Furthermore, in the course of polymerization of a monomer solution to form a polymer, a change in volume occurs and a shape of the core is deformed, leading to a fault of a large transmission loss.

Moreover, B. Michel et al. of IBM Zurich Research Center proposed a high resolution lithographic technique using PDMS and reported that a resolving power of tens of nm is acquired with the technique. A detailed commentary thereon is described in IBM J. REV. & DEV., Vol. 45, No. 5, September, 2001.

As described above, a soft lithographic technique and a capillary micromolding method using PDMS are techniques on which attention has been recently focused in USA as the center.

However, when an optical waveguide is fabricated using a micromolding method as described above, there arises a trade-off between reduction in volume shrinkage in curing (to thereby decrease a transmission loss) and decrease in viscosity of a filling liquid (such as a monomer) for the purpose to facilitate a filling operation, which are incompatible with each other. Therefore, if a higher priority is assigned to reduction in transmission loss, a viscosity of a filling liquid cannot decrease to a limit or lower to as an adverse result, slow a filling speed and disable the method to be expected as one for mass production. Moreover, the micromolding method uses a glass or silicon substrate as a substrate, as a precondition, and no consideration is given to use of a flexible substrate.

### SUMMARY OF THE INVENTION

The present invention was made in light of the problems as described above and it is an object of the invention to provide a process for producing a polymer optical waveguide that is simple and convenient, implemented at a low cost and improved in productivity.

The invention is directed to a process for producing a polymer optical waveguide, comprising the steps of: preparing a mold comprising a concave portion for forming a core; bringing a cladding film substrate into close contact with the mold; rotating the mold with which the cladding film substrate is brought into close contact and with one end of which an ultraviolet ray-curable resin or a thermosetting resin to serve as a core is brought into contact, so that a centrifugal force acts in a direction to move the ultraviolet ray-curable resin or the thermosetting resin into the mold, to fill the concave portion of the mold with the ultraviolet ray-curable resin or the thermosetting resin; and curing the ultraviolet ray-curable resin or the thermosetting resin.

### BRIEF DESCRIPTION OF THE DRAWINGS

FIGS. 1A to 1G are conceptual diagrams showing steps of a fabrication process for a polymer optical waveguide of the present invention.

FIG. 2 is a conceptual diagram showing a step of causing a resin to be introduced into a mold concave portion in a fabrication process for a polymer optical waveguide of the invention.

FIG. 3 is a conceptual diagram showing an example of a mold used in a process for producing a polymer optical waveguide of the invention.

### DETAILED DESCRIPTION OF THE INVENTION

A process for producing a polymer optical waveguide of the present invention includes the following steps:

1) a step of forming a layer of a mold-forming resin material on a master template on which an optical waveguide convex portion is formed and thereafter removing the layer of a mold-forming resin material from the master template to make an impression of the master template, and cutting both ends of a concave portion on the layer of a mold-forming resin material to expose the concave portion corresponding to the optical waveguide convex portion formed on the master template, thereby completing production of a mold;

2) a step of bringing a cladding film substrate, having good adhesiveness to the mold, into close contact with the mold;

3) a step of rotating the mold with which the cladding film substrate is brought into close contact and with one end of which an ultraviolet ray-curable resin or a thermosetting resin to serve as a core is brought into contact so that a centrifugal force acts on the ultraviolet ray-curable resin or the thermosetting resin in a direction to move the ultraviolet ray-curable resin or the thermosetting resin into the mold with the help of capillarity, to fill the concave portion of the mold with the ultraviolet ray-curable resin or the thermosetting resin;

4) a step of curing the ultraviolet ray-curable resin or the thermosetting resin having introduced to then remove the mold from the cladding film substrate; and

5) a step of forming a cladding layer on the cladding film substrate on which the core has been formed.

A process for producing a polymer optical waveguide of the invention is based on the findings that when a cladding film substrate having good adhesiveness with a mold is brought into close contact with the mold as described above, no clearance exists between the mold and the cladding film substrate except for a concave portion structure formed on the mold even without using special means to bring both into close contact with each other (fixing means such as that described in the above Japanese Patent No. 3151364) and the ultraviolet ray-curable resin or the thermosetting resin can be caused to introduce only the above described concave portion and with a centrifugal force adopted on this occasion, the mold concave portion can be quickly filled with a resin; and a process for producing a polymer optical waveguide of the invention is extremely simplified to facilitate fabrication of a polymer optical waveguide and to thereby enable a polymer optical waveguide to be fabricated at an extremely low cost and with a good productivity as compared with a prior art process for producing a polymer optical waveguide. Furthermore, with a process for producing a polymer optical waveguide of the invention applied, a polymer optical waveguide is obtained that has less of a transmission loss and is assured of a high precision and that is so flexible as to enable free application to various kinds of equipment. Furthermore, a shape or the like of a polymer optical waveguide can be freely set.

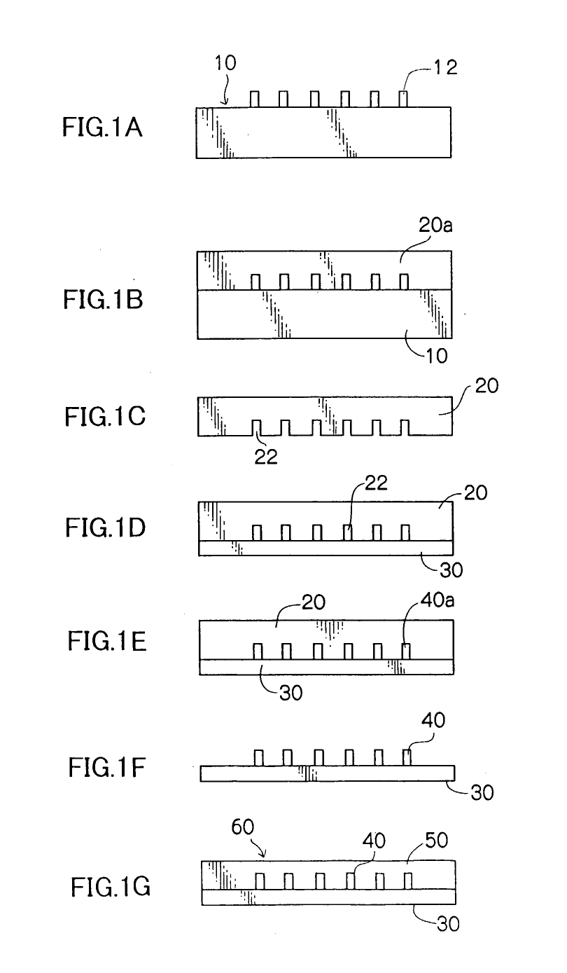

First of all, description will be given of an outline of a process for producing a polymer optical waveguide of the invention with reference to FIGS. 1A to 1G.

FIG. 1A shows a master template 10 on which optical waveguide convex portions 12 are formed. As shown in FIG. 1B, a mold-forming resin material layer 20a (for example, a cured layer of a curable resin) is first formed on a surface of the master template 10 on a surface of which the optical waveguide convex portions 12 are formed. Then, the mold-forming resin material layer 20a is removed from the master template 10 (making an impression of the master template 10) and thereafter, the mold-forming resin material layer 20a is cut at both ends (not shown) so as to expose concave portions 22 corresponding to the optical waveguide convex portions 12 formed on the master template, thereby completing production of a mold 20 (see FIG. 1C).

A cladding film substrate 30 good in adhesiveness to thus produced mold is brought into close contact with the mold (FIG. 1D). Then, one end of the mold is brought into contact with a curable resin 40a serving as a core to cause the resin 40a to introduce the concave portions 22 of the mold using capillarity. FIG. 1E shows a state of the concave portions of the mold which is filled with the curable resin. Thereafter, the curable resin within the concave portions 22 is cured, followed by removing of the mold (not shown). As shown in FIG. 1F, optical waveguide convex portions (core) 40 is formed on the cladding film substrate.

Moreover, a cladding layer 50 is formed on the core forming surface of the cladding film substrate to thereby fabricate a polymer optical waveguide 60 (see FIG. 1G) of the invention.

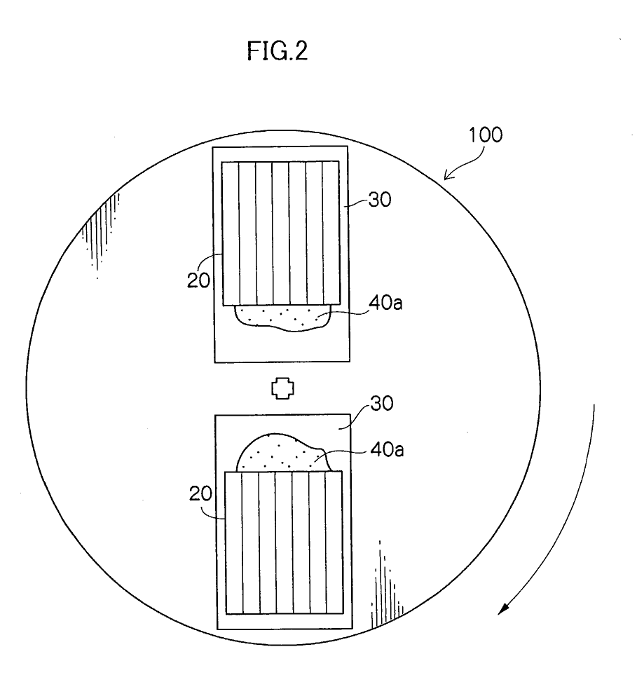

In the step of FIG. 1E, an ultraviolet ray-curable resin or a thermosetting resin serving a core is brought into contact with one end of the mold with which the cladding film substrate is brought into close contact, and the mold and others in the state are rotated so as to cause a centrifugal force to act in a direction in which the ultraviolet ray-curable resin or the thermosetting resin introduces to encourage invasion of the ultraviolet ray-curable resin or the thermosetting resin into the concave portions of the mold by capillarity. In FIG. 2, there is shown a conceptual diagram of this step. A numerical reference 100 shows a spinner controlled in rotation speed. A substrate film 30 larger by one size than the mold 20 is brought into close contact with the mold 20 and a curable resin 40a is brought into contact with one ends of the concave portions of the mold, and the mold and others in this state are placed on the spinner (in a case of FIG. 2, a pair are placed in axial symmetry with respect to a rotation center) and the spinner is rotated at a prescribed rotation speed to thereby, cause a centrifugal force to act in the direction in which the curable resin introduces and to encourage filling of the curable resin into the concave portions of the mold.

Description will be given of a process for producing a polymer optical waveguide according to the invention according to the order of steps of the process below.

1) A Step of Forming a Layer of a Mold-Forming Resin Material on a Master Template on Which an Optical Waveguide Convex Portion is Formed and Thereafter Removing the Layer of a Mold-Forming Resin Material From the Master Template to Make an Impression of the Master Template, and Cutting Both Ends of a Concave Portion on the Layer of a Mold-Forming Resin Material to Expose a Concave Portion Corresponding to the Optical Waveguide Convex Portion Formed on the Master Template, Thereby Completing Production of a Mold

<Preparation of Master Template>

A master template on which optical waveguide convex portions (convex portions corresponding to a core) are formed can be manufactured using a prior art process, for example a photolithographic process without placing any specific limitation thereon. Furthermore, also applied to manufacture a master template is a process for producing a polymer optical waveguide with an electro-deposition method or an optoelectric deposition method an application of which was previously filed for a patent by the applicant of this application (Japanese Patent Application No. 2002-10240). Sizes of optical waveguide convex portions formed on a master template are determined in any suitable means according to an application or the like of a polymer optical waveguide. For example, in a case of an optical waveguide for use in a single mode, a core of the order of 10 square μm is generally used and, in a case of an optical waveguide for use in a multimode, a core of the order in the range of 50 to 100 square μm is generally used, but an optical waveguide having a core portion of a square in section with a side as large as on the order of hundreds of μm is also used according to an application.

<Preparation of Mold>

A mold is prepared in a procedure in which a mold resin material layer is formed on an optical waveguide surface of a master template manufactured as described above and thereafter, the layer is removed therefrom.

It is preferable that a mold resin material can be preferably removed from the master template with ease and a mold therefrom has a mechanical strength and a dimensional stability higher than respective prescribed levels. The layer of a mold resin material is formed with a mold forming resin or a composition obtained by adding various kinds of additive agents to the resin when required.

A mold forming resin has to perfectly copy individual optical waveguides formed on a master template in the impression thereon, so the resin preferably has a viscosity of a value or less, for example of the order in the range of 2000 to 7000 mPa·s. A solvent for modifying a viscosity can be added to a level at which no adverse influence acts.

As mold forming resins, there can be exemplified a curable silicone resin (thermosetting type or a room temperature curing type) which is preferably used from view points of peelability, mechanical strengths and dimensional stability. Furthermore, a low molecular weight liquid resin categorized in the curable silicone resins is preferably used because of sufficient penetrability, which is expectable. A viscosity of the resin is preferably in the range of 500 to 7000 mPa·s and more preferably in the range of 2000 to 5000 mPa·s.

As curable silicone resins, preferable is a curable silicone resin including a methylsiloxane group, an ethylsiloxane group or a phenylsiloxane group, and especially preferable is a curable dimethylsiloxane resin.

Furthermore, it is desirable to promote removing of a mold from the master template by applying a release treatment such as application of a release agent thereon in advance.

In order to form a mold resin material layer on an optical waveguide surface of a master template, the following process is adopted in which a mold forming resin layer is formed on the optical waveguide surface by a method such as application of a mold forming resin, injection molding thereof, or the like, followed by a drying treatment, a curing treatment or the like when required.

A thickness of a mold resin material layer is determined in any suitable way while giving a consideration to handling properties as a mold, and preferably on the order in the range of 0.1 to 50 mm.

After formation of the mold forming resin layer accompanied with a necessary after-treatment, the mold forming resin layer is removed from the master template to obtain an impression thereof.

<Manufacturing of Mold>

Then, the removed layer with concave portions is cut at both ends thereof so as to expose the concave portions corresponding to optical waveguide convex portions formed on the master template, thereby completing production of a mold. The reason why both ends of the removed layer is cut off so as to expose the concave portions is that in a later step, an ultraviolet ray-curable resin or a thermosetting resin is caused to introduce the concave portions of the mold by capillarity.

A surface energy of a mold is preferably in the range from 10 dyn/cm to 30 dyn/cm and more preferably in the range of 15 dyn/cm to 24 dyn/cm in respect to adhesiveness to a substrate film.

A Share rubber hardness of a mold is preferably in the range of 15 to 80 and more preferably in the range of 20 to 60 in consideration of mold making performance and peelability.

A surface roughness of a mold (Root-Mean-Square (RMS)) is preferably 0.5 μm or less and more preferably 0.1 μm or less in consideration of mold making performance.

In a step of causing an ultraviolet ray-curable resin or a thermosetting resin to introduce concave portions of the mold by capillarity in 3), described later, of the invention, the mold with which a cladding film substrate is brought into close contact and with one end of which the ultraviolet ray-curable resin or the thermosetting resin serving as a core is brought into contact is rotated so that a centrifugal force acts on the ultraviolet ray-curable resin or the thermosetting resin in a direction in which the ultraviolet ray-curable resin or the thermosetting resin introduce the mold to encourage the invasion; therefore, the resin is facilitated to introduce a portion other than the concave portions of the mold. For this reason, it is preferable to provide a liquid reservoir section storing the ultraviolet ray-curable resin or the thermosetting resin in the mold in a case where the mold and the cladding film substrate are brought into close contact with each other.

The liquid reservoir is a cut-way portion where there exists no mold-forming resin material layer, the cut-away portion is defined by being surrounded with the mold-forming resin material layer, sections of one ends of the concave portions of the mold are all exposed open to a space the cur-away portion and a volume of the cut-away portion has only to be as large as to be able to store a resin amount enough to fill all of the concave portions of the mold. No specific limitation is imposed on the cut-away portion concerning a shape of a plan view as far as the cut-way portion meets the above described conditions and there can be exemplified a rectangular shape and others.

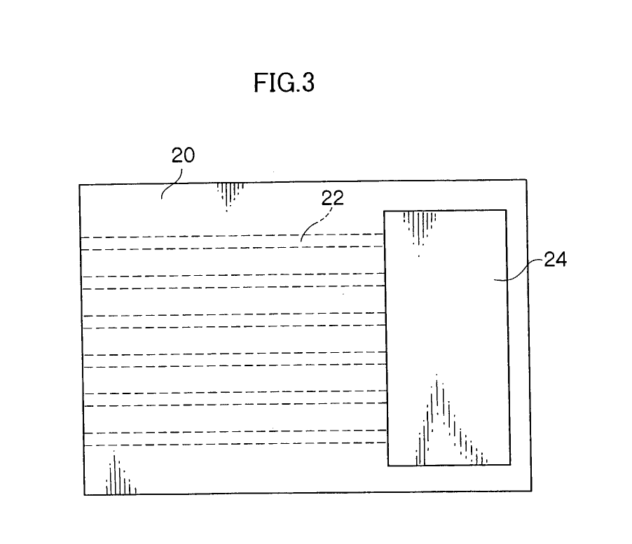

In FIG. 3, there is shown an example of a mold provided with a liquid reservoir section 24. Here, numerical reference 20 shows a mold, and numerical reference 22 shows a concave portion of a mold.

A practical method to form the cut-away portion is to form the portion with a punch cutter after a mold is manufactured, on which no specific limitation is placed.

2) A Step of Bringing a Cladding Film Substrate Good in Adhesiveness to the Mold, Into Close Contact With the Mold

Since an optical waveguide of the invention can also be used as a coupler, optical interconnects between boards, an optical branching filter and others, a film substance material described above is selected according to an application thereof while giving a consideration to optical characteristics such as a refractive index, an optical transmittance, mechanical strengths, heat resistance, adhesiveness to a mold, a flexibility and others. It is preferable to fabricate a polymer optical waveguide having a flexibility using a flexible film substrate. As films described above, there are exemplified an alicyclic acrylic film, an alicyclic olefin film, cellulose triacetate, fluorine containing resin film and others. A refractive index of a film substrate is preferably less than 1.55 and preferably less than 1.53 in order to secure a difference in refractive index between the film substrate and a core.

As alicyclic acrylic film, there can be used OZ-1000, OZ-1100 and others obtained by introducing an alicyclic hydrocarbon such as tricyclodecane into an ester substituent group.

Furthermore, as alicyclic olefin films, there are named those with a norbornene structure in the main chain and with a norbornene structure in the main chain and a polar group such as an alkyloxycarbonyl group in a branched chain (where an alkyl group has 1 to 6 carbon atoms, including a cycloalkyl group). Among them, an alicyclic olefin resin with a norbornene structure in the main chain and a polar group such as an alkyloxycarbonyl group in a branched chain has a low refractive index (a refractive index is approximately 1.50, so a difference in refractive index between a film substrate and a core can be secured) and an excellent optical properties such as a high optical transmittance, and is excellent in adhesiveness to a mold and in heat resistance; therefore, the alicyclic olefin resin is suitable for fabrication of a polymer optical waveguide of the invention.

It is preferable that a thickness of the film substrate is properly selected giving a consideration to a flexibility, stiffness, easiness in handling and others and in general preferably in the range of 0.1 mm to 0.5 mm.

3) A Step of Rotating a Mold With Which a Cladding Film Substrate is Brought Into Close Contact and With One End of Which an Ultraviolet Ray-Curable Resin or a Thermosetting Resin Serving as a Core is Brought Into Contact so That a Centrifugal Force Acts on the Ultraviolet Ray-Curable Resin or the Thermosetting Resin in a Direction in Which the Ultraviolet Ray-Curable Resin or the Thermosetting Resin Introduces to Cause the Ultraviolet Ray-Curable Resin or the Thermosetting Resin to Introduce the Concave Portions of the Mold With the Help of Capillarity

Since in the step, clearances formed between the mold and the film substrate (the concave portions of the mold) are filled with an ultraviolet ray-curable resin or a thermosetting resin by capillarity, the ultraviolet ray-curable resin or the thermosetting resin is necessary to be sufficiently low in viscosity so as to make the filling possible and in addition thereto, a refractive index of the curable resin after curing is necessary to be higher than a polymer material of a cladding layer (a difference in refractive index is 0.02 or more). Still furthermore, the curable resin is necessary to have a small change between volumes before and after curing in order to reproduce an original shape of an optical waveguide convex portions formed on a master template with a high precision. For example, reduction in volume causes a wave guiding loss. Therefore, desirable is a curable resin with the lowest possible change in volume and the change in volume is 10% or less and preferably 6% or less. It is preferable to avoid making a viscosity of a curable resin lower using a solvent since a low viscosity caused by a solvent increases a change between volumes before and after curing.

Therefore, a viscosity of a curable resin is preferably in the range of 10 mPa·s to 2000 mPa·s, more preferably in the range of 20 mPa·s to 1000 mPa·s and further more preferably in the range of 30 mPa·s to 500 mPa·s.

As ultraviolet ray-curable resins, there are preferably used epoxy-based, polyimide-based and acrylic-based ultraviolet ray-curable resins.

Furthermore, in order to promote the filling of a curable resin, it is effective means to heat a curable resin brought into contact with one end of a mold to thereby reduce a viscosity of the curable resin.

As a method to increase a filling speed by enhancement of capillarity, though the method to reduce a viscosity of a curable resin is available as described above, a limitation arises on reduction in the viscosity while maintaining transparency, a refractive index and a degree of volume shrinkage of a polymer for forming an optical waveguide as they are.

Therefore, in the invention, a mold with which a cladding film substrate is brought into close contact and with one end of which an ultraviolet ray-curable resin or a thermosetting resin serving as a core is brought into contact is rotated so that a centrifugal force acts the resin in a direction in which the resin is caused to introduce the mold to thereby increase a filling speed.

Rotation of a mold with which a cladding film substrate is brought into close contact and with one end of which an ultraviolet ray-curable resin or a thermosetting resin serving as a core is brought into contact is usually conducted placing the mold and others in the state on a rotary member such as a rotary disk.

On this occasion, rotary members as described above can be designed in various ways: in addition to a member having a planar surface such as a circular disk, a rotary member of the shape of a disk concave downward (like a shape of a pot or a bowl whose inwardly carved surface faces downward); that is to say, when the mold with which the cladding film substrate is brought into close contact is placed on a surface of the rotary member, the film substrate and the rotary member can take an inclination angle thereof to a plane intersecting with a rotation axis of the rotary member at a right angle in the range of 1° to 45°, wherein a guiding standard is an angle between a line connecting the center of rotation and the gravity center of the mold and the plane, thereby further improving a filling speed.

With increase in centrifugal force, a faster filling speed is realized, but when a centrifugal force exceeding an adhesive force between the mold and the film substrate acts on the mold or the film since the mold also rotates in a similar way, the mold and the film substrate are removed from each other to disable filling the capillaries with a liquid. Accordingly, a gravity center of the mold is preferably located within 200 mm or less from the rotation center and the rotation speed is preferably set to a value of 10000 rpm or less and more preferably 8000 rpm or less.

In order to prevent a mold and a film substrate from being removed from each other, it is effective that a cladding film substance with through holes is adopted and the film is brought into close contact with a mold, and the mold with the cladding film substrate is placed on a rotary member (through the interior of which vacuum suction is enabled) and vacuum-sucked to thereby, bring both the film substrate and the mold into close contact with the rotary member and to fix both thereon, and when such a measure is performed, a rotation speed can be adopted that is further larger than the above described value.

A refractive index of a cured product of an ultraviolet ray-curable resin or a thermosetting resin serving as a core is necessary to be larger than the film substrate serving as a cladding layer (including a cladding layer in a step of 5) described later) and is 1.53 or more and preferably 1.55 or more. A difference in refractive index between a cladding layer (including a cladding layer in the step of 5) described later) and a core is 0.02 or more and more preferably 0.05 or more.

4) A Step of Curing the Introduced Ultraviolet Ray-Curable Resin or Thermosetting Resin to Remove the Mold From the Film Substrate

The introduced ultraviolet ray-curable resin or thermosetting resin are cured. An ultraviolet lamp, an ultraviolet LED, an UV irradiation apparatus or the like is used for curing the ultraviolet ray-curable resin. Furthermore, heating in an oven or the like is adopted for curing the introduced thermosetting resin.

It is also possible to use a mold used in steps 1) to 3) as a cladding layer without any further treatment and in this case, no necessity arises for removing the mold to use the mold as a cladding layer as it is.

5) A Step of Forming a Cladding Layer on a Film Substrate on Which a Core Has Been Formed

A cladding layer is formed on a film substrate on which a core is formed and as the cladding layer, for example, a film substrate as used in a step of 2) is similarly used and there is named a layer obtained by applying a curable resin (an ultraviolet ray-curable resin or a thermosetting resin) to form a coat and to cure the coat, a polymer film obtained by applying a polymer material solution in a solvent to form a coat and to dry the coat or the like. In a case where a film is used as a cladding layer, the film is brought into close contact with the film substrate with an adhesive and on this occasion, a refractive index of the adhesive is desirably close to a refractive index of the film.

A refractive index of a cladding layer is preferably less than 1.55 and more preferably less than 1.53 in order to secure a difference in refractive index between the core and the cladding layer. Furthermore, it is preferable that a refractive index of the cladding layer is the same as that of the film substrate for the purpose of confinement of light.

In a process for producing a polymer optical waveguide of the invention, adhesiveness between a mold and a film substrate in a combination including as mold materials, especially thermosetting silicone resins, and among them, a thermosetting dimethyl siloxane resin, and as film substrates, an alicyclic olefin resin having a norbornene structure in a main chain thereof and a polar group such as an alkyloxycarbonyl group in a branched chain thereof is especially high and, in such combination, even when a sectional area of the concave portion structure is extremely small, (for example, a rectangle of 10×10 μm in size), the concave portions can be quickly filled with a curable resin by capillarity.

Furthermore, a mold can also be used as a cladding layer and in this case, it is preferable that a refractive index of the mold is 1.5 or less and the mold is subjected to an ozone treatment in order to increase adhesiveness between the mold and a core material and in addition, an optical transmittance of the mold is 80% or higher at a wavelength in the region of from 350 nm to 700 nm.

Description will be given of embodiments of the invention below:

As a first embodiment, the invention provides a process for producing a polymer optical waveguide, comprising the steps of: preparing a mold comprising a concave portion for forming a core; bringing a cladding film substrate into close contact with the mold; rotating the mold with which the cladding film substrate is brought into close contact and with one end of which an ultraviolet ray-curable resin or a thermosetting resin to serve as a core is brought into contact, so that a centrifugal force acts in a direction to move the ultraviolet ray-curable resin or the thermosetting resin into the mold, to fill the concave portion of the mold with the ultraviolet ray-curable resin or the thermosetting resin; and curing the ultraviolet ray-curable resin or the thermosetting resin.

As a second embodiment, the invention provides a process for producing a polymer optical waveguide according to the first embodiment, wherein a liquid reservoir section for an ultraviolet ray-curable resin or a thermosetting resin is formed in the mold.

As a third embodiment, the invention provides a process for producing a polymer optical waveguide according to the first embodiment, wherein the mold is prepared by forming a layer of a mold-forming resin material on a master template possessing a convex portion corresponding to an optical waveguide, removing the layer of a mold-forming resin material from the master template to make an impression possessing a concave portion corresponding to the optical waveguide convex portion, and cutting an end of the layer of the mold-forming resin material to expose the concave portion.

As a fourth embodiment, the invention provides a process for producing a polymer optical waveguide according to the third embodiment, wherein the layer of the mold-forming resin material is obtained by curing a curable silicone resin.

As a fifth embodiment, the invention provides a process for producing a polymer optical waveguide according to the first embodiment, wherein the cladding film substrate and the mold which have been brought into close contact with each other are placed on a rotary member so as to form an angle in a range of 1° to 45° with a plane that is orthogonal to a rotation axis of the rotary member, and rotated by the rotary member.

As a sixth embodiment, the invention provides a process for producing a polymer optical waveguide according to the first embodiment, wherein the cladding film substrate is provided with through holes, and the cladding film substrate and the mold which have been brought into close contact with each other are placed on a rotary member through which vacuum suction is enabled to bring both the cladding film substrate and the mold into close contact with the rotary member by vacuum suction so as to cause both the cladding film substrate and the mold to be held by the rotary member without moving thereon.

As a seventh embodiment, the invention provides a process for producing a polymer optical waveguide according to the first embodiment, wherein a surface energy of the mold is 10 dyn/cm to 30 dyn/cm.

As a eighth embodiment, the invention provides a process for producing a polymer optical waveguide according to the first embodiment, wherein a Share rubber hardness of the mold is 15 to 80.

As a ninth embodiment, the invention provides a process for producing a polymer optical waveguide according to the first embodiment, wherein a surface roughness of the mold is 0.5 μm or less.

As a tenth embodiment, the invention provides a process for producing a polymer optical waveguide according to the first embodiment, wherein a thickness of the mold is 0.1 mm to 50 mm.

As an eleventh embodiment, the invention provides a process for producing a polymer optical waveguide according to the first embodiment, wherein a refractive index of the cladding film substrate is 1.55 or less.

As a twelfth embodiment, the invention provides a process for producing a polymer optical waveguide according to the first embodiment, wherein the cladding film substrate comprises an alicyclic olefin resin.

As a thirteenth embodiment, the invention provides a process for producing a polymer optical waveguide according to the twelfth embodiment, wherein the alicyclic olefin resin comprises a resin having a norbornene structure in a main chain thereof and a polar group in a side chain thereof.

As a fourteenth embodiment, the invention provides a process for producing a polymer optical waveguide according to the first embodiment, wherein a viscosity of the ultraviolet ray-curable resin or the thermosetting resin is 10 mPa·s to 2000 mPa·s.

As a fifteenth embodiment, the invention provides a process for producing a polymer optical waveguide according to the first embodiment, wherein a change in volume of the ultraviolet ray-curable resin or the thermosetting resin when being cured is 10% or less.

As a sixteenth embodiment, the invention provides a process for producing a polymer optical waveguide according to the first embodiment, wherein a diameter of the core is in a range of 10 μm to 500 μm.

As a seventeenth embodiment, the invention provides a process for producing a polymer optical waveguide according to the first embodiment, wherein a refractive index of a cured product of the ultraviolet ray-curable resin or the thermosetting resin is 1.55 or greater.

As a eighteenth embodiment, the invention provides a process for producing a polymer optical waveguide according to the first embodiment, wherein the mold is used as a cladding layer.

As a nineteenth embodiment, the invention provides a process for producing a polymer optical waveguide according to the first embodiment, further comprising the steps of removing the mold from the cladding film substrate, and forming a cladding layer on the cladding film substrate on which the core has been formed.

As a twentieth embodiment, the invention provides a process for producing a polymer optical waveguide according to the nineteenth embodiment, wherein formation of the cladding layer is achieved by applying an ultraviolet ray-curable resin or a thermosetting resin, and subsequently curing the same.

As a twenty-first embodiment, the invention provides a process for producing a polymer optical waveguide according to the nineteenth embodiment, wherein formation of the cladding layer is achieved by laminating a cladding film with an adhesive having a refractive index that is close to a refractive index of the cladding film.

As a twenty-second embodiment, the invention provides a process for producing a polymer optical waveguide according to the nineteenth embodiment, wherein a refractive index of the cladding layer is substantially the same as a refractive index of the cladding film substrate.

As a twenty-third embodiment, the invention provides a process for producing a polymer optical waveguide according to the nineteenth embodiment, wherein a difference between a refractive index of the cladding film substrate and a refractive index of the core is 0.02 or greater, and a difference between a refractive index of a cladding layer and the refractive index of the core is 0.02 or greater.

As a twenty-fourth embodiment, the invention provides an injection apparatus for filling a concave portion of an optical waveguide-forming mold with a curable resin, comprising: a rotary member; and a holding member, provided on a surface of the rotary member, for holding a cladding film substrate and an optical waveguide forming mold.

### EXAMPLES

While description will be given of the invention, showing examples in a more detailed fashion below, it should be understood that the present invention is not limited to the examples.

### Example 1

A thick film resist (made by Microchemical Corp., with a trade mark SU-8) was applied on a Si substrate using a spin coat method, thereafter the coat on the Si substrate was prebaked at 80° C., the resist was exposed to light through a photomask, the exposed resist was developed to form a convex portion with a section in the shape of a square (50 μm in width, 50 μm in height and 150 mm in length). Then, the convex portion is post baked at 120° C. to form a master template for forming an optical waveguide core.

Next, a release agent was applied on the master template, thereafter, a thermosetting dimethylsiloxane resin (made by Dow Corning Asia Ltd., with a trade mark SYLGARD 184) was poured onto the master template and heated at 120° C. for 30 min so as to be cured, thereafter, a cured layer was removed from the master template to prepare an impression mold (a thickness of the mold was 3 mm) having a concave portion corresponding to the convex portion in the shape of a square in section. Then, both ends of the impression mold were cut off to form input/output sections for the following ultraviolet ray-curable resin, thereby completing production of a mold.

A pair of specimens each were prepared by the following procedure in which the mold was brought into close contact with a film substrate (made by JSR Corporation, with a trade name of Arton film having a refractive index of 1.510) with 188 μm in thickness and an area a size larger than the mold, and a few drops of a ultraviolet ray-curable resin (made by JSR Corporation, with a trade mark of PJ3001) with 1300 mPa·s in viscosity were dropped at the input/output section at one end of the mold. The pair of specimens were placed on a planar surface of a spinner as shown in FIG. 2 in axial symmetry with respect to the center of rotation thereof and the pair of specimens were rotated at a rotation speed of 5000 rpm for one min to thereby, cause the concave portion of the mold to be filled with the ultraviolet ray-curable resin. Then, the ultraviolet ray-curable resin was irradiated with UV light at an illuminance of 50 mW/cm² through the mold for 10 min so as to be cured with ultraviolet rays. When the mold was removed from the Arton film, it was observed that a core with the same shape as the convex portion of the master template was formed on the Arton film. A refractive index of the core is 1.591.

Then, a ultraviolet ray-curable resin (made by JSR Corporation) with 1.510 in refractive index after curing same as that of the Arton film was applied all over the core forming surface of the Arton film, thereafter the ultraviolet ray-curable resin was irradiated with UV light at an illuminance of 50 mW/cm² for 10 min so as to be cured with ultraviolet rays (film thickness after curing was 10 μm). A flexible polymer optical waveguide was attained. A loss of the polymer optical waveguide was 0.33 dB/cm.

### Example 2

A master template for fabricating an optical waveguide core having a convex portion with a section in the shape of a square (50 μm in width, 50 μm in height and 150 mm in length) was manufactured according to the same method as in the Example 1. Then, a mold was manufactured in a procedure in which an impression mold was prepared in the same method as in the Example 1; and thereafter both ends of the impression mold are cut off and a liquid reservoir section is formed by shearing out the impression mold with a punch cutter so as to form a liquid reservoir section as shown in FIG. 3. A pair of specimens each were prepared by the following procedure in which the mold was brought into close contact with a film substrate (made by JSR Corporation, with a trade name of Arton film with 188 μm in thickness) and a few drops of a thermosetting resin (made by JSR Corporation) with 500 mPa·s in viscosity were dropped at the input/output section at one end of the mold. The pair of specimens were placed on a planar surface of a spinner as shown in FIG. 2 in axial symmetry with respect to the center of rotation thereof and the pair of specimens were rotated at a rotation speed of 2000 rpm for one min to thereby, cause the concave portion of the mold to be filled with the thermosetting resin. Then, the thermosetting resin in the concave portion was heated in an oven at 130° C. for 30 min to heat cure. When the mold was removed from the Arton film, it was observed that a core with the same shape as the convex portion of the master template was formed on the Arton film. A refractive index of the core was 1.570. Then, a thermosetting resin (made by JSR Corporation) having a refractive index after curing of 1.510, which is the same as that of the Arton film, was applied all over the surface of the Arton film, thereafter the thermosetting resin was heat cured (a film thickness after curing is 10 μm). A flexible polymer optical waveguide was attained. A loss of the polymer optical waveguide was 0.33 dB/cm.

### Example 3

A polymer optical waveguide was fabricated in a similar manner to the way in the Example 1 except that, in the case of the Example 1, a mold with which a cladding film substrate is brought into close contact is placed on a surface of a spinner so that an angle between a line connecting the center of rotation and the gravity center of the mold and the plane intersecting with a rotary axis at a right angle is 30°. Filling of an ultraviolet ray-curable resin is further improved as compared with the case of the Example 1.

### Example 4

A polymer waveguide was fabricated in a similar way to the way in the Example 3 except that, in the case of the Example 3, a substrate film with through holes (a diameter of 0.5 mm) and vacuum suction is applied at a side surface of a spinner with a vacuum pump to thereby the substrate film and a mold are fixedly brought into close contact with a surface of the spinner. The substrate film and the mold are fixed firmly on the surface of a spinner without any movement.

### Comparative Example 1

A mold was prepared in a similar way to the way in the Example 1. The mold was brought into contact with a glass substrate (a thickness of 500 μm) a size larger than the mold, a few drops of a ultraviolet ray-curable resin (made by JSR Corporation) with 3000 mPa·s in viscosity were dropped at one end of the mold, after dropping the few drops, the specimen was kept stationary as they were and the concave portion of a mold was filled with the resin by an action of capillarity in which case it took 24 hours to fill a length of 5 cm.

Then, the resin was irradiated with UV light at an illuminance of 50 mW/cm² from a side of the mold for 10 min to cure the resin to then, remove the mold from the glass substrate to form a core of 1.591 in refractive index on the glass substrate. Furthermore, an ultraviolet ray-curable resin of 1.510 in refractive index same as the glass substrate was applied on the surface of the glass substrate on which the core was formed, thereafter the resin was irradiated with UV light at an illuminance of 50 mW/cm² for 10 min to cure the resin and to fabricate a flexible polymer optical waveguide. A loss of the polymer optical waveguide was 0.33 dB/cm.

A process for producing a polymer optical waveguide of the invention has a extremely simplified fabrication process to thereby enable a polymer optical waveguide to be fabricated with ease and according to a process for producing a polymer optical waveguide of the invention, a polymer optical waveguide can be fabricated at an extremely low cost as compared with a prior art process for producing a polymer optical waveguide. Furthermore, according to a process for producing a polymer optical waveguide of the invention, there can be obtained a flexible polymer optical waveguide with a small loss and a high precision, and capable of freely incorporated in various kinds of equipment. In addition thereto, free setting is enabled as to a shape and others of a polymer optical waveguide fabricated according to a fabrication method of the invention.

Besides, an introducing speed of a curable resin into a concave portion or concave portions of a mold is increased to thereby improve productivity since a centrifugal force is used when the curable resin is caused to introduce into the concave portion or concave portions of the mold.

What is claimed is:

1. A process for producing a polymer optical waveguide, comprising the steps of:
preparing a mold comprising a concave portion for forming a core;
bringing a cladding film substrate into close contact with the mold;
rotating the mold with which the cladding film substrate is brought into close contact and with one end of which an ultraviolet ray-curable resin or a thermosetting resin to serve as a core is brought into contact, so that a centrifugal force acts in a direction to move the ultraviolet ray-curable resin or the thermosetting resin into the mold, to fill the concave portion of the mold with the ultraviolet ray-curable resin or the thermosetting resin; and
curing the ultraviolet ray-curable resin or the thermosetting resin.

2. A process for producing a polymer optical waveguide according to claim 1, wherein a liquid reservoir section for an ultraviolet ray-curable resin or a thermosetting resin is formed in the mold.

3. A process for producing a polymer optical waveguide according to claim 1, wherein the mold is prepared by forming a layer of a mold-forming resin material on a master template possessing a convex portion corresponding to an optical waveguide, removing the layer of a mold-forming resin material from the master template to make an impression possessing a concave portion corresponding to the optical waveguide convex portion, and cutting an end of the layer of the mold-forming resin material to expose the concave portion.

4. A process for producing a polymer optical waveguide according to claim 3, wherein the layer of the mold-forming resin material is obtained by curing a curable silicone resin.

5. A process for producing a polymer optical waveguide according to claim 1, wherein the cladding film substrate and the mold which have been brought into close contact with each other are placed on a rotary member so as to form an angle in a range of 1° to 45° with a plane that is orthogonal to a rotation axis of the rotary member, and rotated by the rotary member.

6. A process for producing a polymer optical waveguide according to claim 1, wherein the cladding film substrate is provided with through holes, and the cladding film substrate and the mold which have been brought into close contact with each other are placed on a rotary member through which vacuum suction is enabled to bring both the cladding film substrate and the mold into close contact with the rotary member by vacuum suction so as to cause both the cladding film substrate and the mold to be held by the rotary member without moving thereon.

7. A process for producing a polymer optical waveguide according to claim 1, wherein a surface energy of the mold is 10 dyn/cm to 30 dyn/cm.

8. A process for producing a polymer optical waveguide according to claim 1, wherein a Share rubber hardness of the mold is 15 to 80.

9. A process for producing a polymer optical waveguide according to claim 1, wherein a surface roughness of the mold is 0.5 μm or less.

10. A process for producing a polymer optical waveguide according to claim 1, wherein a thickness of the mold is 0.1 mm to 50 mm.

11. A process for producing a polymer optical waveguide according to claim 1, wherein a refractive index of the cladding film substrate is 1.55 or less.

12. A process for producing a polymer optical waveguide according to claim 1, wherein the cladding film substrate comprises an alicyclic olefin resin.

13. A process for producing a polymer optical waveguide according to claim 12, wherein the alicyclic olefin resin comprises a resin having a norbornene structure in a main chain thereof and a polar group in a side chain thereof.

14. A process for producing a polymer optical waveguide according to claim 1, wherein a viscosity of the ultraviolet ray-curable resin or the thermosetting resin is 10 mPa·s to 2000 mPa·s.

15. A process for producing a polymer optical waveguide according to claim 1, wherein a change in volume of the ultraviolet ray-curable resin or the thermosetting resin when being cured is 10% or less.

16. A process for producing a polymer optical waveguide according to claim 1, wherein a diameter of the core is in a range of 10 μm to 500 μm.

17. A process for producing a polymer optical waveguide according to claim 1, wherein a refractive index of a cured product of the ultraviolet ray-curable resin or the thermosetting resin is 1.55 or greater.

18. A process for producing a polymer optical waveguide according to claim 1, wherein the mold is used as a cladding layer.

19. A process for producing a polymer optical waveguide according to claim 1, further comprising the steps of removing the mold from the cladding film substrate, and forming a cladding layer on the cladding film substrate on which the core has been formed.

20. A process for producing a polymer optical waveguide according to claim 19, wherein formation of the cladding layer is achieved by applying an ultraviolet ray-curable resin or a thermosetting resin, and subsequently curing the same.

21. A process for producing a polymer optical waveguide according to claim 19, wherein formation of the cladding layer is achieved by laminating a cladding film with an adhesive having a refractive index that is close to a refractive index of the cladding film.

22. A process for producing a polymer optical waveguide according to claim 19, wherein a refractive index of the cladding layer is substantially the same as a refractive index of the cladding film substrate.

23. A process for producing a polymer optical waveguide according to claim 19, wherein a difference between a refractive index of the cladding film substrate and a refractive index of the core is 0.02 or greater, and a difference between a refractive index of a cladding layer and the refractive index of the core is 0.02 or greater.

24. An apparatus for filling a concave portion of an optical waveguide-forming mold with a curable resin, comprising:
a rotary member; and
a holding member, provided on a surface of the rotary member, for holding a cladding film substrate and an optical waveguide forming mold.
